(19) United States
(12) Patent Application Publication
(10) Pub. No.: US 2015/0278907 A1
(43) Pub. Date: Oct. 1, 2015

(54) User Inactivity Aware Recommendation System

(71) Applicant: Microsoft Corporation, Redmond, WA (US)

(72) Inventors: Nir Nice, Kfar Veradim (IL); Noam Koenigstein, Raanana (IL); Ulrich Paquet, Cambridge (GB); Shahar Keren, Hemed (IL)

(73) Assignee: Microsoft Corporation, Redmond, WA (US)

(21) Appl. No.: 14/226,896

(22) Filed: Mar. 27, 2014

(51) Int. Cl. G06Q 30/06; G06N 7/00; G06F 17/16

(52) U.S. Cl. CPC G06Q 30/0631; G06F 17/16; G06N 7/00

(57) ABSTRACT

Example apparatus and methods perform matrix factorization (MF) on a usage matrix to create a latent space that describes similarities between users and items in the usage matrix. The usage matrix relates users to items according to a collaborative filtering approach. A cell in the usage matrix may store a value that describes whether a user has acquired an item and the strength with which the user likes an item that has been acquired. Example apparatus and methods account for negative indications analytically rather than through negative sampling. Example apparatus and methods analyze strengths in the usage matrix, analyze item popularity, analyze user popularity, compute contribution factors for items with respect to users and users with respect to items, and compute new user vectors and new item vectors that depend on the strengths, popularity, and contributions. A recommendation may consider new user vectors and new item vectors.

### BACKGROUND

Conventional recommendation systems provide information about matches between users (e.g., shoppers) and items (e.g., books, videos, games) based on user interests, preferences, history, or other factors. For example, if a system has data that a user has previously accessed (e.g., purchased, rented, borrowed, played) a set of items, then a recommendation system may identify similar items and recommend them to the user based on the data about the user's own actions (e.g., “if you liked this, you might like that”). Conventional systems may assume that if there is no data that a user acquired, accessed, viewed, or otherwise interacted with an item then the user does not like that item.

There are two major types of conventional recommendation systems: collaborative filtering based systems and feature based systems. Feature based systems may also be referred to as content based systems. Collaborative filtering depends on actual user events (e.g., user who bought/watched/read an item). Feature based systems describe features (e.g., author, actor, genre) of items. Different techniques (e.g., matrix factorization, nearest neighbor) may be used to compute item similarities and then to provide recommendations based on the similarities. These techniques may rely on both positive indications (e.g., user purchased item) and negative indications (e.g., user did not access/purchase item, user gave item a bad review).

Conventional matrix factorization models map users and items to a joint latent factor space and model user-item interactions as inner products in the joint latent factor space. An item may be associated with an item vector whose elements measure the extent to which the item possesses some factors. Similarly, a user may be associated with a user vector whose elements measure the extent of interest the user has in items that are high in corresponding factors. The dot product of the vectors may describe the interaction between the user and item and may be used to determine whether to make a recommendation to a user. More specifically, every user i may be assigned a vector uᵢ in a latent space, and every item j may also be assigned a vector vⱼ in the latent space. The dot product uᵢ·vⱼ represents the score between the user i and the item j. The score represents the strength of the relationship between the user i and the item j and may be used to make a recommendation (e.g., recommend item with highest score). Conventional systems may arbitrarily provide negative scores for different subsets of missing data. Some conventional systems may add biases in the form of scalar parameters that indicate the popularity of a user or item. When a bias has been added in the form of a scalar parameter, the score function may be: uᵢ^{T}vⱼ+bᵢ^{user}+bⱼ^{item}. In this case, the inner product uᵢ^{T}vⱼ describes the “personalization” for a user. The personalization may be offset against the user and items' baseline popularity rate.

When computing recommendations for a specific user i using matrix factorization, all the items j in the catalog may be scored. Typically, matrix factorization requires that there be some positive scores and some negative scores, otherwise the solutions may be trivial and of no practical use. Discreet systems where, for example, users provide a numerical score (e.g., number of stars) for an item may be well suited to matrix factorization. However, users typically only provide ratings for items they have accessed. Similarly, in binary usage systems, there may only be positive indications (e.g., indication that user watched a movie, indication that user played a game, indication that user purchased a book). There may not be any negative indications (e.g., user did not watch movie, user did not play game, user did not purchase book, user did not access/acquire/use item). Thus, in either discreet or binary systems, data may not be available for all combinations of i and j. However, matrix factorization requires that there be data for its computations. Therefore, conventional systems may “negatively sample” to provide artificial scores for items for which there is no data. Different negative sampling strategies may be employed by conventional systems. For example, if a user has ten positive indications (e.g., watched ten movies), then an equal number of negative indications may be generated. During matrix factorization, several different iterations may be performed where several different random sets of ten items are selected for negative sampling.

After all the items j have been scored, with some scores being actual scores and some scores having been provided by negative sampling, the highest scoring items may be selected and recommended. This may be represented as: given i, find j=arg max uᵢ·vⱼ. In mathematics, arg max is the argument of the maximum, which is defined as the set of points of the given argument for which the given function attains its maximum value.

$$arg {max}_{x} f ( x ) := \{ x \vert ∀ y : f ( y ) \leq f ( x ) \}$$

In other words, arg maxₓ f(x) is the set of values of x for which f(x) attains its largest value M. For example, if f(x) is 1−|x|, then it attains its maximum value of 1 at x=0 and only there, so argmaxₓ (1−|x|)={0}. While finding the maximum scoring item for a user may produce an adequate result, when the scoring is based on arbitrary negative sampling, then undesirable results may be produced.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods use an analytic approach to account for an entire set of unused signals rather than using negative sampling of different sets of items. The analytic approach is more accurate than conventional systems because the analytic approach accounts for all unused signals. The analytic approach is deeper than conventional systems because the analytic approach accounts for the strength of a like signal. For example, numbers of views, length of play, or other indicia of satisfaction with an item may be considered. The analytic approach also facilitates using techniques (e.g., MapReduce framework) that model large data sets (e.g., millions of users, millions of items). Example apparatus and methods may create a first cache that accounts for all indications for users, and may update user vectors in parallel using the first cache. Example apparatus and methods may also create a second cache that accounts for all indications for items, and may update item vectors in parallel using the second cache. The caches may be created using a single iteration over the user space or item space in the usage matrix.

In one example, an apparatus includes a memory that stores data concerning a user's inactivity. The inactivity data may be acquired by iterating over a data set (e.g., usage matrix) a single time to create a cache. Iterating through the usage matrix a single time may be performed in O(N) time, where N is the number of items iterated over. Conventional systems may perform a O(N²M) process, where N is the number of items iterated over and M is the number of users. Data in the cache may be weighted to model the relevance of certain indications. For example, an actual dislike of an extremely popular item may be more relevant than an assumed dislike of an obscure item. A user's total contributions may then be computed by subtracting a user's positive indications from the cache data of all indications. When subtracting a user's specific items from the cache in order to compute the analytical negatives for a user, how much the user liked the item will be taken into account.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example metric space.

FIG. 2 illustrates an example of accounting for a user's contributions in a metric space.

FIG. 3 illustrates an example method associated with accounting for user inactivity in a recommendation system without negative sampling.

FIG. 4 illustrates an example method associated with accounting for user inactivity in a recommendation system without negative sampling.

FIG. 5 illustrates an example apparatus associated with accounting for user inactivity in a recommendation system without negative sampling.

FIG. 6 illustrates an example apparatus associated with accounting for user inactivity in a recommendation system without negative sampling.

FIG. 7 illustrates an example cloud operating environment in which a recommendation system that accounts for user inactivity without negative sampling may operate.

FIG. 8 is a system diagram depicting an exemplary mobile communication device configured to participate in a recommendation system that accounts for user inactivity without negative sampling.

FIG. 9 provides additional detail concerning producing second electronic data in a method for producing a recommendation.

### DETAILED DESCRIPTION

Example apparatus and methods provide a recommendation system that accounts for user inactivity without using negative sampling. Negative sampling may be inaccurate, may be shallow, may create engineering difficulties, may miss highly relevant dislikes, and may produce an intractable issue concerning matching power-law characteristics, among other issues. Negative sampling involves selecting items for which there is no data, assigning an arbitrary negative indication to the items, and performing matrix factorization. Different sets of items may be selected at different times during matrix factorization. Assigning arbitrary negative indications may help explain positive indications, but may produce several sub-optimal results. For example, negative sampling may be inaccurate, may be shallow, may create engineering difficulties, may miss highly relevant dislikes, and may produce an intractable issue concerning matching power-law characteristics, among other issues.

Negative sampling may be inaccurate. If a user watched a relatively small number of movies (e.g., 50 out of 2,000,000 available), then the negative sampling does not accurately represent the user's inactivity because the sampling size (e.g., 50 random movies selected to offset the 50 positive indications) is trivial compared to the actual data set size. Additionally, the “fact” that the user didn't like the movie is fabricated. The data set may accurately reflect that a user acquired or accessed an item, but just because there is no indication that the user acquired or accessed the item from this vendor does not mean the user didn't acquire or access the item elsewhere, it just means that this data set doesn't have data about whether the user accessed the item.

Negative sampling may be shallow in that it may only produce a “like/dislike” signal, and may not capture how much a user liked an item. For example, a like/dislike signal may treat equally a game that a user plays for an hour every day, a game that the user plays for one hour per week, a game that the user occasionally plays for fifteen minutes, and a game that the user purchased, played once for ten minutes, and has never played again. The difference in how much a user likes an item can be valuable in matrix factorization, but conventionally is not modeled in negative sampling scenarios because it is not possible to sample fractions of use.

Negative sampling may create engineering difficulties because negative sampling increases (e.g., doubles) the size of the data set to be processed by matrix factorization and requires additional O(N²) processing. Additionally, negative sampling selects different sets of items at different times during matrix factorization to be arbitrarily assigned negative values. Thus, negative sampling may produce data that is not well suited to technology for modelling very large data sets (e.g., MapReduce framework).

Negative sampling may miss highly relevant dislikes. Not all likes and dislikes are the same and not all likes and dislikes ought to contribute to a similarity contribution equally. For example, the fact that a user likes an extremely popular item may not be as important to producing a customized recommendation for that user as is the fact that a user likes a collection of obscure items that few other people like. Additionally, the fact that a user has not acquired or dislikes an obscure item that no-one else likes or has acquired may be less important in understanding this user than the fact that the user disliked an extremely popular item. Since negative sampling randomly selects items to which negative indications are attached, the most relevant dislikes (e.g., of an extremely popular item) may be missed.

Negative sampling may produce an intractable issue concerning matching power-law characteristics. If a user accessed ten items, then negative sampling typically assigns arbitrary negative indications to around ten items, not to a hundred thousand items. Similarly, for an item that has been accessed a hundred thousand times, negative sampling typically does not proceed with just ten negative samples. Producing appropriate numbers of negative indications for users and items may be possible when the usage matrix includes only binary like/dislike signals. However, an intractable issue arises in negative sampling when the usage matrix models the strength of a like. For example, for a user who has accessed ten items with a total weight of ten, should negative sampling produce ten negative indications each with a weight of one or one negative indication with a weight of ten? Similarly, for a user who has accessed one item with a total weight of ten, should negative sampling produce one negative indication or ten?

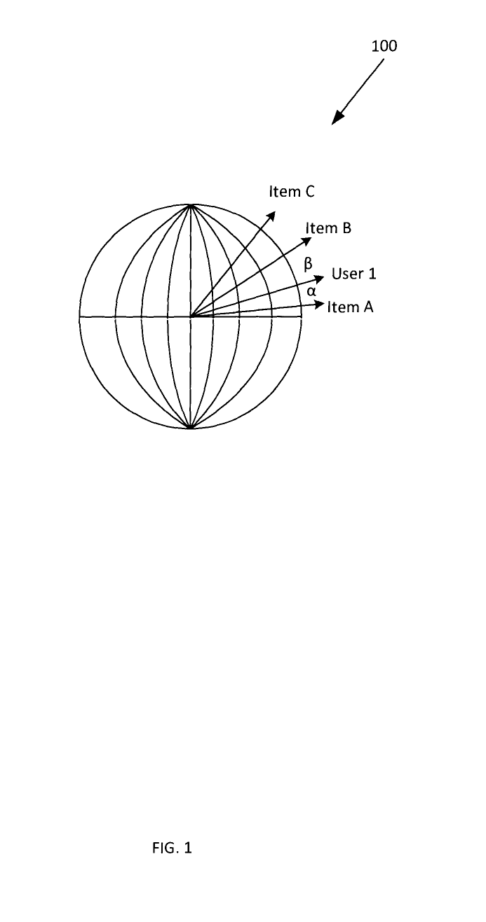

FIG. 1 illustrates a metric space 100 where the distance between items is defined. For example, the distance between a first vector associated with a first item and a second vector associated with a first user may be measured by angle α and the distance between the second vector and a third vector associated with a third item can be measured by β. The distance between items may describe, for example, how similar the items are. While distance is illustrated being measured by angles, other distance measuring approaches may be applied.

Conventionally, the metric space 100 may have been created by performing matrix factorization on a user-to-item usage matrix and thus the distance between a user item and vector item could be found. Missing data in the user-to-item usage matrix may have been accounted for using negative sampling. Example apparatus and methods do not perform negative sampling. Instead, example apparatus and methods account for user activity in a different way. Example apparatus and methods use an analytic method to represent a user's inactivity. The analytic method may factor the strength of a positive signal.

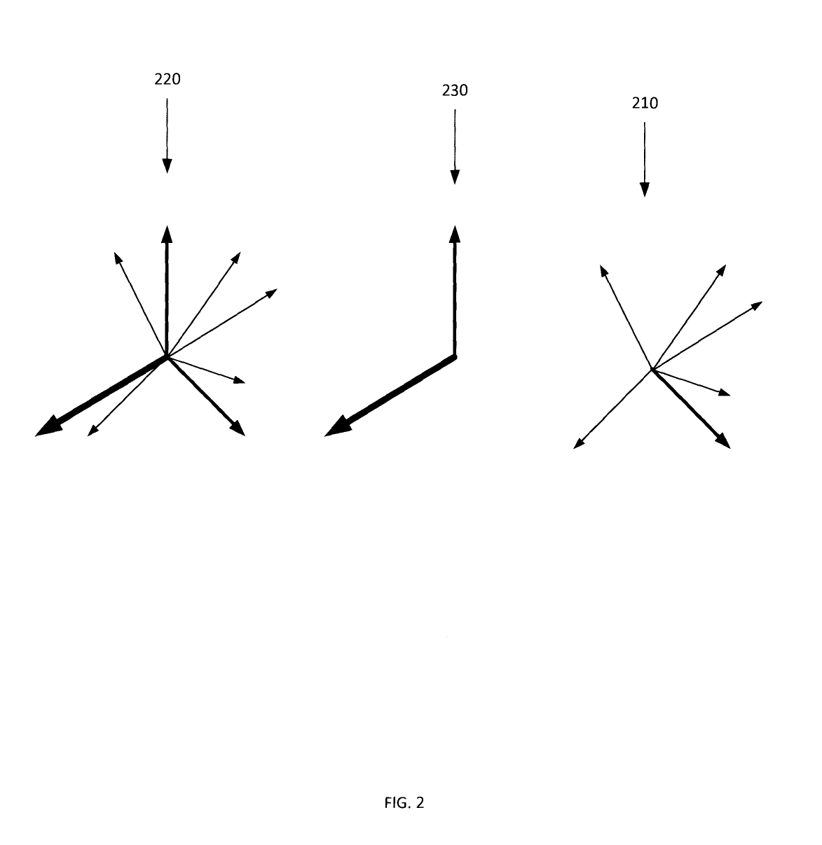

FIG. 2 illustrates a metric space where a user's negative contribution 210 is computed by subtracting a user's positive indications 230 from a cache 220. The cache 220 may represent the weighted sum of all contributions. In FIG. 2, the width of a vector may represent the weight of a like or a dislike associated with the user or item represented by the vector.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, distributions, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

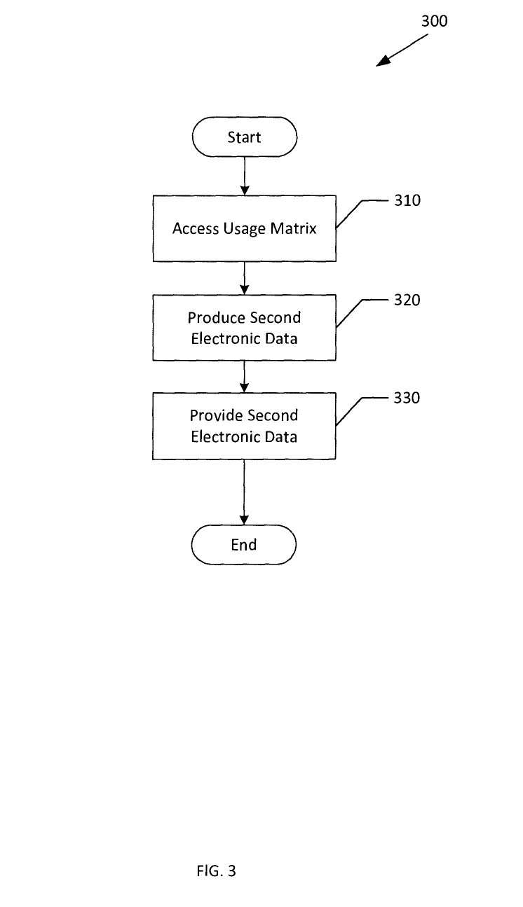

FIG. 3 illustrates an example method 300 associated with accounting for user inactivity in a recommendation system without using negative sampling. Method 300 may include, at 310, accessing a usage matrix (M) that stores electronic data concerning a set of users U and a set of items V. In one embodiment, the users may be represented in rows in the usage matrix and the items may be represented in columns in the usage matrix. The electronic data stored in the usage matrix describes the fact that a user i accessed an item j and describes the strength with which user i liked item j. In different embodiments, the acquisition of item j may involve making a purchase, playing a game, reading a book, watching a display, or other action. The user i may be described by a vector mᵢ associated with the usage matrix and the item j may be described by a vector mⱼ associated with the usage matrix. The elements of vectors mᵢ and mⱼ measure the extent to which the entity associated with the vector possesses the factors associated with the dimensions in M. The first electronic data describes collaborative filtering based user to item interactions, where a user i is related to an item j by a strength cᵢⱼ.

Method 300 may also include, at 320, producing second electronic data associated with a latent item space. The latent item space facilitates identifying similarities between items. The second electronic data may be produced from M by applying a matrix factorization process on vectors associated with members of the set of users U and on vectors associated with members of the set of items V. In one embodiment, the second electronic data includes a vector uᵢ that represents user i and a vector vⱼ that represents item j. Unlike conventional systems, the matrix factorization process does not perform negative sampling. Instead, the matrix factorization process considers collectively the contributions of users to items or vice versa. The contributions between different users and different items may have different importance or weights, which may be captured by popularity factors. Thus, producing the second electronic data may depend, at least in part, on the popularity of items represented in M or on the popularity of users represented in M.

Method 300 may compute an item popularity factor t for items represented in M. In one embodiment, t is a probability vector that accounts for all items represented in M. In another embodiment, t is a probability vector that accounts for less than all items represented in M. In one embodiment, method 300 may compute t by normalizing an item histogram associated with M and t may sum to one.

Method 300 may compute a user popularity factor s for users represented in M. In one embodiment, s is a probability vector that accounts for all users represented in M. In another embodiment, s may account for less than all users represented in M. Method 300 may compute s by normalizing a user histogram associated with M and s may sum to one.

In different embodiments, producing the second electronic data depends on at least ten percent of the strengths cᵢⱼ in M, on at least twenty five percent of the strengths cᵢⱼ in M, on at least fifty percent of the strengths cᵢⱼ in M, or on at least ninety percent of the strengths cᵢⱼ in M. In one embodiment, all the strengths cᵢⱼ in M may be considered.

In one embodiment, producing the second electronic data depends on determining a total contribution factor U_{cache} for all items represented in M with respect to all users represented in M. U_{cache} is a vector. In one embodiment, U_{cache} is computed according to:

U_{cache}=Σⱼ₌₁^{J}tⱼvⱼ,

where tⱼ represents a popularity of item j and J represents the total number of items represented in M. In one embodiment, an additional cache P_{cache} may be computed. P_{cache} may represent a weighted sum of outer products and may be computed using:

P_{cache}=Σⱼtⱼvⱼvⱼ^{T}.

P_{cache} may help prevent having updates to uᵢ become unwieldy. A user-side cache usercache={U_{cache}, P_{cache}} that includes a vector and a matrix can then be created. P_{cache} may be used to produce a Hessian matrix Pᵢ for user i. In one embodiment, the Hessian matrix may be used to scale updating. The Hessian matrix may be computed using:

Pᵢ=sᵢDP_{cache}+Σ_{j viewed by i}cᵢⱼvⱼvⱼ^{T}.

In one embodiment, usercache may include biases or other parameters. For example, usercache may be extended to:

usercache={{U_{cache},P_{cache}},{U_{cache}^{bias},P_{cache}^{bias}}}

where U_{cache}^{bias}, P_{u:cache}^{bias} are two more scalar parameters.

In one embodiment, producing the second electronic data depends on determining a total contribution factor I_{cache} for all users represented in M with respect to all items represented in M. I_{cache} is a vector. In one embodiment, I_{cache} is computed according to:

I_{cache}=Σᵢ₌₁^{I}sᵢuᵢ,

where sᵢ represents a popularity of user i and where I represents the total number of users represented in M. In one embodiment, an additional cache Q_{cache} may be computed. Q_{cache} may represent a weighted sum of outer products and may be computed using:

Q_{cache}=Σᵢsᵢuᵢuᵢ^{T}.

Q_{cache} may help prevent having updates to vⱼ become unwieldy. An item-side cache itemcache={I_{cache}, Q_{cache}} that includes a vector and a matrix can then be created. Q_{cache} may be used to produce a Hessian matrix Qⱼ for item j. In one embodiment, the Hessian matrix may be used to scale updating. The Hessian matrix may be computed using:

$${Q}_{j} = {t}_{j} {DQ}_{cache} + {\sum }_{i who viewed j} {c}_{ij} {u}_{i} {u}_{i}^{T}$$

Producing the second electronic data may also include computing a plurality of new user vectors associated with the latent space. In one embodiment, the plurality of new user vectors may be computed in parallel. In one embodiment, a new user vector uᵢ for a user i may be computed according to:

uᵢ=−sᵢDU_{cache}+Σ_{jviewed}cᵢⱼvⱼ,

where D is a function of all values cᵢⱼ in M.

In another embodiment, new user vector uᵢ for a user i may be computed according to:

uᵢ=Pᵢ⁻¹[−sᵢDU_{cache}+Σ_{j viewed by i}cᵢvⱼ].

In yet another embodiment, new user vector uᵢ for a user i may be computed according to:

uᵢ=(1−ε)uᵢ^{old}+ε[−sᵢDU_{cache}+Σ_{j viewed by i}cᵢⱼvⱼ],

where ε represents a step size.

Producing the second electronic data may also include computing a plurality of new item vectors. The item vectors may be computed in parallel. In one embodiment, a new item vector vⱼ for an item j is computed according to:

$${v}_{j} = - {t}_{j} {DI}_{cache} + {\sum }_{Ipresent} {c}_{ij} {u}_{i} .$$

In another embodiment, a new item vector vⱼ for an item j is computed according to:

vⱼ=Qⱼ⁻¹[−tⱼDI_{cache}+Σ_{i who viewed j}cᵢⱼuᵢ].

In yet another embodiment, a new item vector vⱼ for an item j is computed according to:

vⱼ=(1−ε)vⱼ^{old}+ε[−tⱼDI_{cache}+Σ_{i who viewed j}cᵢⱼuᵢ],

where ε represents a step size.

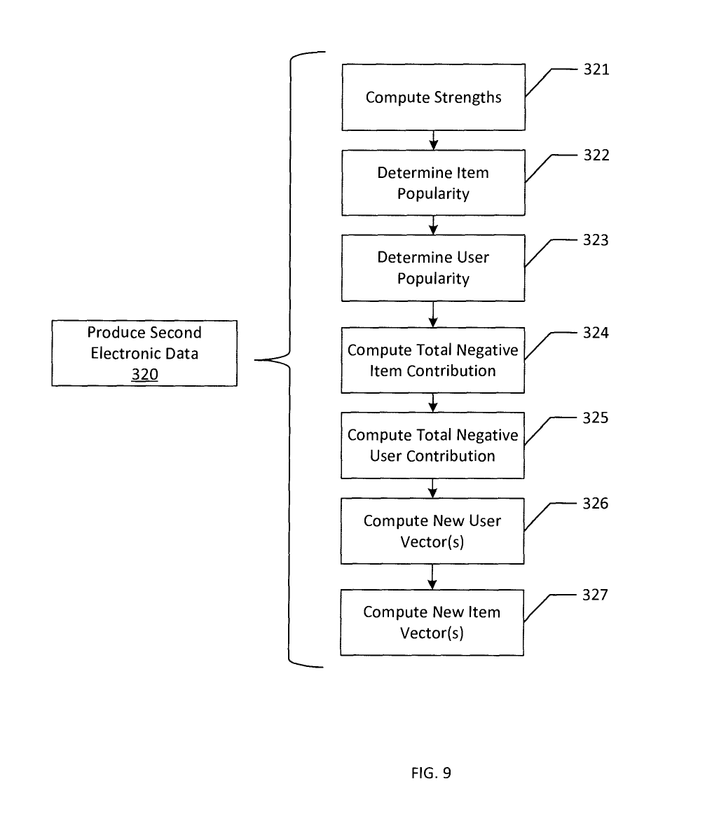

FIG. 9 illustrates one example order in which the second electronic data may be produced at 320. For example, a strength factor may be computed at 321, item popularity may be computed at 322, and user popularity may be computed at 323. A total item contribution may be computed at 324 and a total user contribution may be computed at 325. With the strengths, popularities, and total contributions available, new user vectors may be computed at 326 and new item vectors may be computed at 327.

Returning now to FIG. 3, method 300 may also include, at 330, providing the second electronic data for use in making a recommendation of an item to acquire. Providing the second electronic data may include storing the data in a memory, writing the data to a data structure (e.g., database table), transmitting the data over a data communication channel, providing the data to a cloud service, or other action.

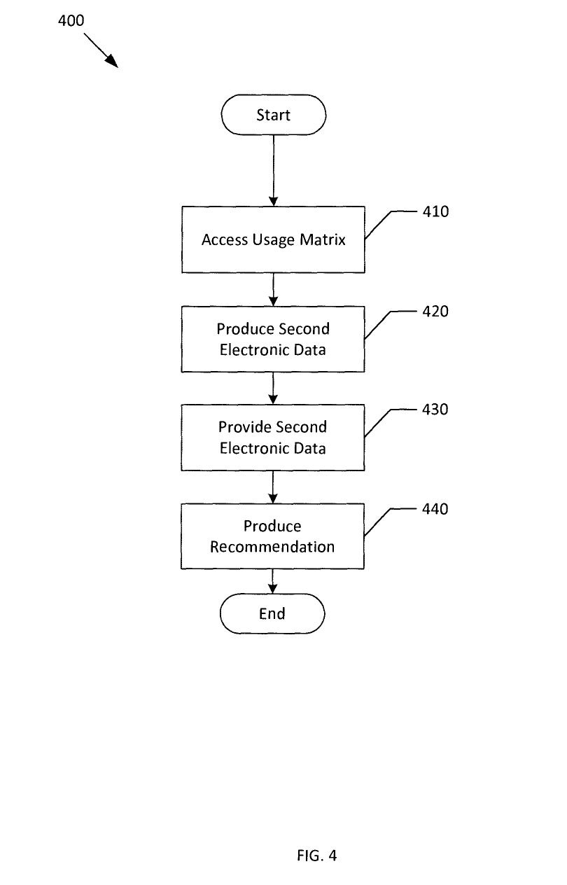

FIG. 4 illustrates another example method 400 associated with accounting for user inactivity in a recommendation system without using negative sampling. Method 400 includes several actions similar to method 300. For example, method 400 includes, at 410, accessing a usage matrix produced by a collaborative filtering recommendation system, producing second electronic data at 420, and providing the second electronic data at 430. However, method 400 includes additional actions. For example, method 400 includes, at 440, producing the recommendation of the item to acquire. The recommendation may depend, at least in part, on the plurality of new item vectors and the plurality of new user vectors. In one embodiment, the recommendation may be determined by identifying the highest score for an item given another item. Producing the recommendation may include displaying an item identifier to a user via a computer display, sending electronic data to a user via an email, text, tweet, or other electronic communication, providing a uniform resource locator (URL) to a user, or other action.

While FIGS. 3 and 4 illustrates various actions occurring in serial, it is to be appreciated that various actions illustrated in FIGS. 3 and 4 could occur substantially in parallel. By way of illustration, a first process could produce caches that account for contributions, a second process could update vectors in parallel using the caches, and a third process could make recommendations based on the updated vectors. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 300 or 400. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

“Computer-readable storage medium”, as used herein, refers to a medium that stores instructions or data. “Computer-readable storage medium” does not refer to propagated signals, per se. A computer-readable storage medium may take forms, including, but not limited to, non-volatile media, and volatile media. Non-volatile media may include, for example, optical disks, magnetic disks, tapes, flash memory, read only memory (ROM), and other media. Volatile media may include, for example, semiconductor memories, dynamic memory (e.g., dynamic random access memory (DRAM), synchronous dynamic random access memory (SDRAM), double data rate synchronous dynamic random-access memory (DDR SDRAM), etc.), and other media. Common forms of a computer-readable storage medium may include, but are not limited to, a floppy disk, a flexible disk, a hard disk, a magnetic tape, other magnetic medium, a compact disk (CD), a random access memory (RAM), a read only memory (ROM), a memory chip or card, a memory stick, and other media from which a computer, a processor or other electronic device can read.

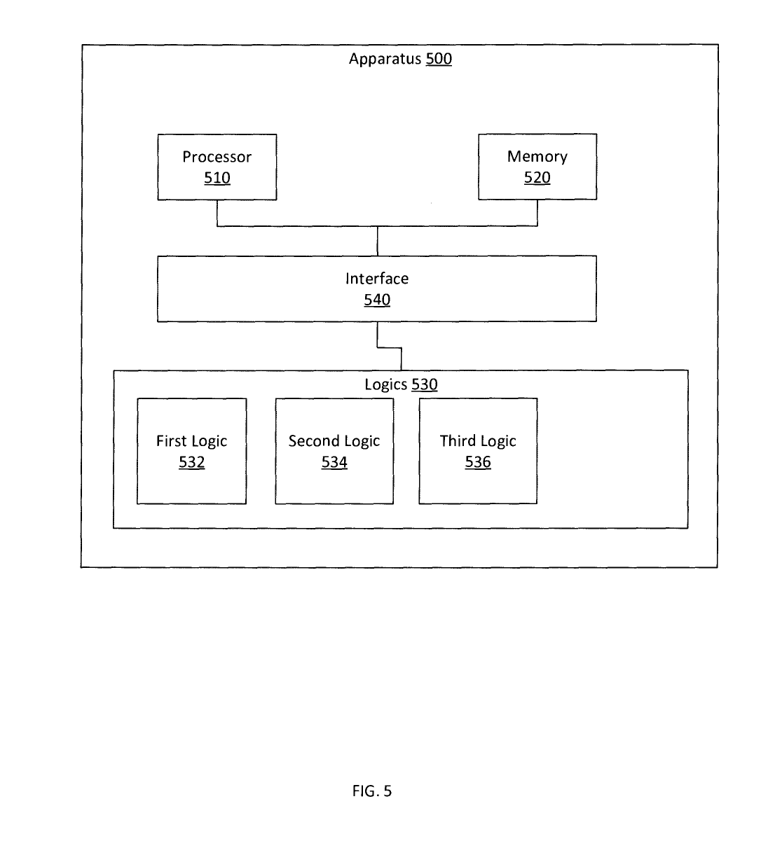

FIG. 5 illustrates an apparatus 500 that produces a recommendation based on data that accounts for user inactivity without negative sampling. Apparatus 500 may include a processor 510, a memory 520, a set 530 of logics, and an interface 540 that connects the processor 510, the memory 520, and the set 530 of logics. The processor 510 may be, for example, a microprocessor in a computer, a specially designed circuit, a field-programmable gate array (FPGA), an application specific integrated circuit (ASIC), a processor in a mobile device, a system-on-a-chip, a dual or quad processor, or other computer hardware. The memory 520 may store data (e.g., vector mᵢ) representing a user i, may store data (e.g., vector mⱼ) representing an item j, may store a sum of known strengths from the usage matrix, may store data from which a probability vector that models the popularity of users can be computed, may store a probability vector that models the popularity of users, may store data from which a probability vector that models the popularity of items can be computed, may store a probability vector that models the popularity of items, or may store other data. Thus, memory 520 may store data associated with making a recommendation based on a collaborative filtering approach that accounts for user inactivity without using negative sampling.

In one embodiment, the apparatus 500 may be a general purpose computer that has been transformed into a special purpose computer through the inclusion of the set 530 of logics. Apparatus 500 may interact with other apparatus, processes, and services through, for example, a computer network. Apparatus 500 may be, for example, a computer, a laptop computer, a tablet computer, a personal electronic device, a smart phone, a system-on-a-chip (SoC), or other device that can access and process data.

The set 530 of logics may facilitate producing improved recommendations from data that accounts for user inactivity without performing negative sampling. The set 530 of logics may produce data upon which a recommendation for an item to acquire can be made. The data may be associated with, for example, a latent space that facilitates identifying distances between vectors that represent users and items.

The set 530 of logics may include a first logic 532 that accesses a collaborative filtering based user-item usage matrix M. Usage matrix M stores a strength cᵢⱼ between a user i and an item j. The first logic 532 may compute a strength factor D from strengths cᵢⱼ in M. In one embodiment, D is computed as the sum of all strengths cᵢⱼ in M. In another embodiment, D is computed as a function of a non-empty subset of all the strengths cᵢⱼ in M.

The first logic 532 may compute an item popularity factor t for items represented in M. In one embodiment, t is a probability vector that accounts for all items represented in M. In another embodiment, t is a probability vector that accounts for less than all items represented in M. First logic 532 may compute t by normalizing an item histogram associated with M or through other approaches. t may sum to one. In one embodiment, entries in t are proportional to the amount of usage or total strength for items. Thus, t may be thought of as the effective item data set size or the effective item strength.

The first logic 532 may also compute a user popularity factor s for users represented in M. In one embodiment, s is a probability vector that accounts for all users represented in M. In another embodiment, s may account for less than all users represented in M. First logic 532 may compute s by normalizing a user histogram associated with M. s may sum to one. In one embodiment, entries in s are proportional to the amount of usage or total strength for users. Thus, s may be thought of as the effective user data set size or the effective user strength.

The set 530 of logics may also include a second logic 534 that computes a contribution factor U_{cache} for items represented in M. The contribution factor U_{cache} accounts for indications between items and users represented in M. The contribution factor U_{cache} may be based, at least in part, on the item popularity factor t. The popularity factor t facilitates accounting for the fact that some users may be “more popular” than other users. The popularity of a user may be determined, for example, by how many items represented in M the user has accessed. In one embodiment, the second logic 534 computes U_{cache} for all items represented in M with respect to all users represented in M according to:

$${U}_{cache} = {\sum }_{j = 1}^{J} {t}_{j} {v}_{j}$$

where tⱼ is a popularity factor for item j, and J is the number of items represented in M.

In one embodiment, an additional cache P_{cache} may be computed. P_{cache} may represent a weighted sum of outer products and may be computed using:

P_{cache}=Σⱼtⱼvⱼvⱼ^{T}.

P_{cache} may help prevent having updates to uᵢ become unwieldy. A user-side cache usercache={U_{cache}, P_{cache}} that includes a vector and a matrix can then be created. P_{cache} may be used to produce a Hessian matrix Pᵢ for user i. In one embodiment, the Hessian matrix may be used to scale updating. The Hessian matrix may be computed using:

Pᵢ=sᵢDP_{cache}+Σ_{j viewed by i}cᵢⱼvⱼvⱼ^{T}.

In one embodiment, usercache may include biases or other parameters. For example, usercache may be extended to:

usercache={{U_{cache},P_{cache}},{U_{cache}^{bias},P_{cache}^{bias}}},

where {U_{cache}^{bias}, P_{u:cache}^{bias}} are two more scalar parameters.

Second logic 534 may also compute a contribution factor I_{cache} for users represented in M. The contribution factor I_{cache} accounts for indications between users and items represented in M. The contribution factor I_{cache} may be based, at least in part, on the user popularity factor s. The popularity factor s facilitates accounting for the fact that some items may be “more popular” than other items. The popularity of an item may be determined, for example, by how many users represented in M have accessed the item. In one embodiment, the second logic computes I_{cache} for all users represented in M with respect to all items represented in M according to:

I_{cache}=Σᵢ₌₁^{I}sᵢuᵢ,

where sᵢ is a popularity factor for user i, and I is the number of users represented in M. In one embodiment, an additional cache Q_{cache} may be computed. Q_{cache} may represent a weighted sum of outer products and may be computed using:

Q_{cache}=Σᵢsᵢuᵢuᵢ^{T}.

Q_{cache} may help prevent having updates to vⱼ become unwieldy. An item-side cache itemcache={I_{cache}, Q_{cache}} that includes a vector and a matrix can then be created. Q_{cache} may be used to produce a Hessian matrix Qⱼ for item j. In one embodiment, the Hessian matrix may be used to scale updating. The Hessian matrix may be computed using:

Qⱼ=tⱼDQ_{cache}+Σ_{i who viewed j}cᵢⱼuᵢuᵢ^{T}.

The set 530 of logics may also include a third logic 536 that computes a new user vector as a function of s, D, and the contribution factor U_{cache}. In one embodiment, third logic 536 may, additionally or alternatively, compute a new item vector as a function of t, D, and the contribution factor I_{cache}. After computing the new item vector or the new user vector, third logic 536 may store data associated with the new user vector or the new item vector. A recommendation may then be made based on the data associated with the new user vector(s) or the new item vector(s). Third logic 536 may compute more than one new user vector and more than one new item vector. In one embodiment, the third logic 536 computes two or more new user vectors in parallel according to:

$${u}_{i} = - {s}_{i} {DU}_{cache} + {\sum }_{j viewed by i} {c}_{ij} {v}_{j} .$$

In another embodiment, new user vector uᵢ for a user i may be computed according to:

uᵢ=Pᵢ⁻¹[−sᵢDU_{cache}+Σ_{j viewed by i}cᵢⱼvⱼ],

In yet another embodiment, new user vector uᵢ for a user i may be computed according to:

uᵢ=(1−ε)uᵢ^{old}+ε[−sᵢDU_{cache}+Σ_{j viewed by i}cᵢⱼvⱼ],

where ε represents a step size.

In one embodiment, the third logic 536 computes two or more new item vectors in parallel according to:

$${v}_{j} = - {t}_{j} {DI}_{cache} + {\sum }_{i who viewed j} {c}_{ij} {u}_{i} .$$

In another embodiment, a new item vector vⱼ for an item j is computed according to:

vⱼ=Qⱼ⁻¹[−tⱼDI_{cache}+Σ_{i who viewed j}cᵢⱼuᵢ].

In yet another embodiment, a new item vector vⱼ for an item j is computed according to:

vⱼ=(1−ε)vⱼ^{old}+ε[−tⱼDI_{cache}+Σ_{i who viewed j}cᵢⱼuᵢ],

where ε represents a step size.

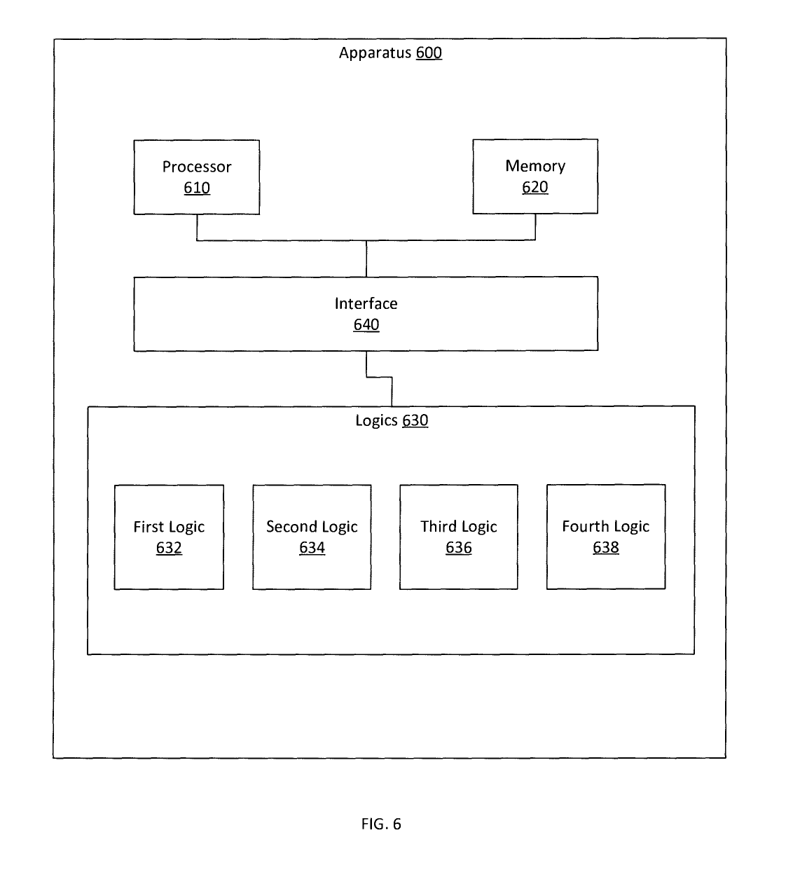

FIG. 6 illustrates an apparatus 600 that is similar to apparatus 500 (FIG. 5). For example, apparatus 600 includes a processor 610, a memory 620, a set of logics 630 (e.g., 632, 634, 636) that correspond to the set of logics 530 (FIG. 5) and an interface 640. However, apparatus 600 includes an additional fourth logic 638. Fourth logic 638 may produce a recommendation for an item to acquire. The recommendation may be based, at least in part, on the new user vector(s) and the new item vector(s) produced by the third logic 636. The recommendation may be made with respect to a single item associated with a user, with a plurality of items associated with a user, with a single item associated with a plurality of users, or with a plurality of items associated with a plurality of users.

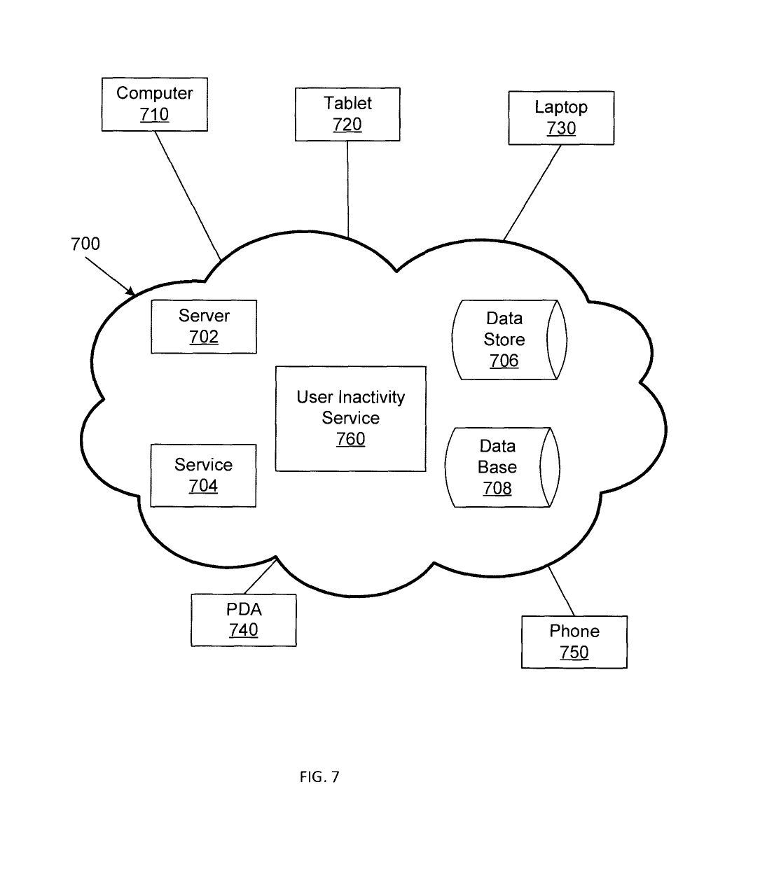

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example user inactivity service 760 residing in the cloud. The user inactivity service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the user inactivity service 760.

FIG. 7 illustrates various devices accessing the user inactivity service 760 in the cloud. The devices include a computer 710, a tablet 720, a laptop computer 730, a personal digital assistant 740, and a mobile device (e.g., cellular phone, satellite phone, wearable computing device) 750. The user inactivity service 760 may produce a recommendation for a user concerning a potential acquisition (e.g., purchase, rental, borrowing). The user inactivity service 760 may produce data from which the recommendation may be made. The data may be produced without using negative sampling. Instead the data may be produced by determining a user's positive contributions in a usage matrix, identifying a sum of the contribution of items with respect to the user, and subtracting the positive contributions from the sum of the contributions.

It is possible that different users at different locations using different devices may access the user inactivity service 760 through different networks or interfaces. In one example, the user inactivity service 760 may be accessed by a mobile device 750. In another example, portions of user inactivity service 760 may reside on a mobile device 750.

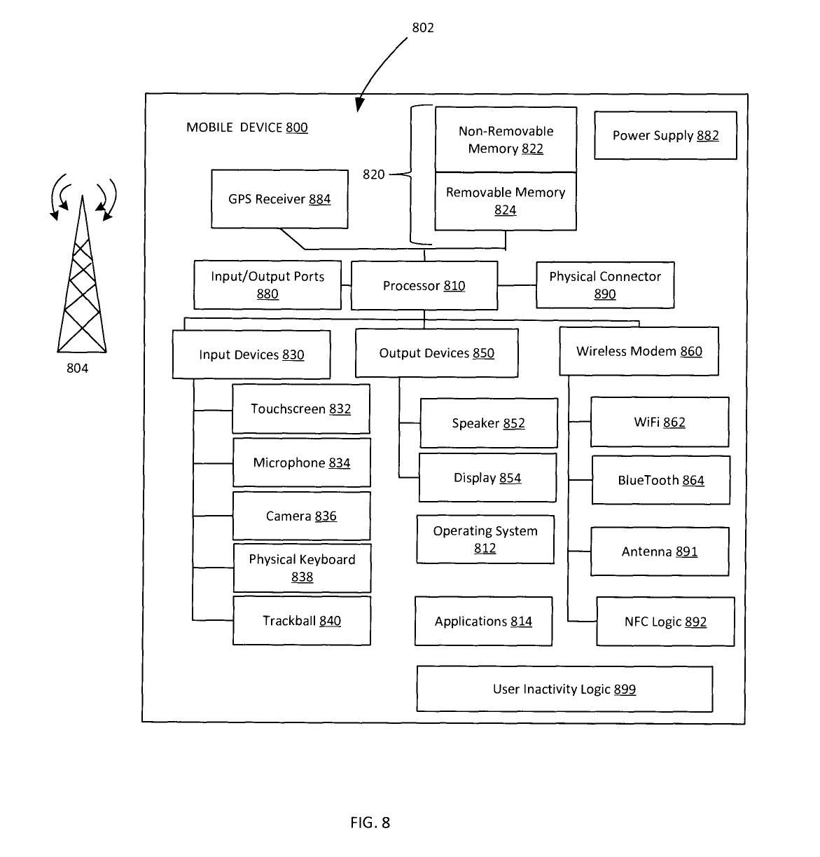

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), wearable computing device, etc.) and may allow wireless two-way communications with one or more mobile communications networks 804, such as a cellular or satellite network.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include recommendation applications, user inactivity applications, recommendation applications, matrix factorization applications, mobile computing applications (e.g., email applications, calendars, contact managers, web browsers, messaging applications), video games, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include user vectors, item vectors, latent space data, recommendations, sales analytics data, positive indications data, negative indications data, or other data. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting gestures to provide input to a recommendation application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). NFC logic 892 facilitates having near field communications (NFC).

The mobile device 800 may include at least one input/output port 880, a power supply 882, a satellite navigation system receiver 884, such as a Global Positioning System (GPS) receiver, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include user inactivity logic 899 that is configured to provide a functionality for the mobile device 800. For example, user inactivity logic 899 may provide a client for interacting with a service (e.g., service 760, FIG. 7). Portions of the example methods described herein may be performed by user inactivity logic 899. Similarly, user inactivity logic 899 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store electronic data. A data store may be, for example, a database, a table, a file, a list, a queue, a heap, a memory, a register, and other physical repository. In different examples, a data store may reside in one logical or physical entity or may be distributed between two or more logical or physical entities. Storing electronic data in a data store causes a physical transformation of the data store.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a processor;
a memory that stores data associated with making a recommendation based on a collaborative filtering approach that accounts for user inactivity without using negative sampling;
a set of logics that produce data upon which the recommendation for an item to acquire can be made; and
an interface to connect the processor, the memory, and the set of logics;
the set of logics comprising:
a first logic that:
accesses a collaborative filtering based user-item usage matrix M that stores a strength cᵢⱼ between a user i and an item j, i and j being integers;
computes a strength factor D from strengths in M;
computes an item popularity factor t for items represented in M,
and
computes a user popularity factor s for users represented in M;
a second logic that:
computes a contribution factor U_{cache} for items represented in M with respect to users represented in M based, at least in part, on the item popularity factor t, and
computes a contribution factor I_{cache} for users represented in M with respect to items represented in M based, at least in part, on the user popularity factor s;
and
a third logic that:
computes a new user vector as a function of s, D, and the contribution factor U_{cache};
computes a new item vector as a function of t, D, and the contribution factor I_{cache}, and
stores data associated with the new user vector and the new item vector.

2. The apparatus of claim 1, comprising a fourth logic that produces the recommendation for an item to acquire based, at least in part, on the new user vector and the new item vector.

3. The apparatus of claim 2, where D is computed as the sum of all strengths cᵢⱼ in M.

4. The apparatus of claim 3, where t is a probability vector that accounts for all items represented in M and sums to one.

5. The apparatus of claim 4, where t is computed by normalizing an item histogram associated with M.

6. The apparatus of claim 5, where s is a probability vector that accounts for all users represented in M and sums to one.

7. The apparatus of claim 6, where s is computed by normalizing a user histogram associated with M.

8. The apparatus of claim 7, where the second logic computes U_{cache} for all items represented in M with respect to all users represented in M according to:
U_{cache}=Σⱼ₌₁^{J}tⱼvⱼ,
where tⱼ is a popularity factor for item j, vⱼ is a vector associated with item j, and J is the number of items represented in M.

9. The apparatus of claim 8, where the second logic computes I_{cache} for all users represented in M with respect to all items represented in M according to:
I_{cache}=Σᵢ₌₁^{I}sᵢuᵢ,
where sᵢ is a popularity factor for user i, uᵢ is a vector associated with user i, and I is the number of users represented in M.

10. The apparatus of claim 9, where the third logic computes two or more new user vectors in parallel according to:
uᵢ=−sᵢDU_{cache}+Σ_{jviewed}cᵢⱼvⱼ.

11. The apparatus of claim 10, where the third logic computes two or more new item vectors in parallel according to:
vⱼ=−tⱼDI_{cache}+Σᵢₚᵣₑₛₑₙₜcᵢⱼuᵢ.

12. The apparatus of claim 11, where the fourth logic produces the recommendation based, at least in part, on the two or more new user vectors and on the two or more the new item vectors.

13. The apparatus of claim 9, where the second logic creates a cache P_{cache} according to:
$${P}_{cache} = {\sum }_{j} {t}_{j} {v}_{j} {v}_{j}^{T}$$
and where the second logic creates a collection usercache, where usercache={U_{cache}, P_{cache}}.

14. The apparatus of claim 13, where the third logic computes a Hessian matrix Pᵢ for user i according to:
Pᵢ=sᵢDP_{cache}+Σ_{j viewed by i}cᵢⱼvⱼvⱼ^{T},
and where the third logic computes two or more new user vectors in parallel according to:
uᵢ=Pᵢ⁻¹[−sᵢDU_{cache}+Σ_{j viewed by i}cᵢⱼvⱼ].

15. The apparatus of claim 13, where the third logic computes a Hessian matrix Pᵢ for user i according to:
Pᵢ=sᵢDP_{cache}+Σ_{j viewed by i}cᵢⱼvⱼvⱼ^{T},
and where the third logic computes two or more new user vectors in parallel according to:
uᵢ=(1−ε)uᵢ^{old}+ε[−sᵢDU_{cache}+Σ_{j viewed by i}cᵢⱼvⱼ],
where ε represents a step size.

16. The apparatus of claim 9, where the second logic creates a cache Q_{cache} according to:
$${Q}_{cache} = {\sum }_{i} {s}_{i} {u}_{i} {u}_{i}^{T}$$
where the second logic creates a collection itemcache, where itemcache={I_{cache}, Q_{cache}}.

17. The apparatus of claim 16, where the third logic computes a Hessian matrix Qⱼ for an item j according to:
$${Q}_{j} = {t}_{j} {DQ}_{cache} + {\sum }_{i who viewed j} {c}_{ij} {u}_{i} {u}_{i}^{T}$$
and where the third logic computes two or more new item vectors in parallel according to:
vⱼ=Qⱼ⁻¹[−tⱼDI_{cache}+Σ_{i who viewed j}cᵢⱼuᵢ].

18. The apparatus of claim 16, where the third logic computes a Hessian matrix Qⱼ an item j according to:
Qⱼ=tⱼDQ_{cache}+Σ_{i who viewed j}cᵢⱼuᵢuᵢ^{T},
and
where the third logic computes two or more new item vectors in parallel according to:
vⱼ=(1−ε)vⱼ^{old}+ε[−tⱼDI_{cache}+Σ_{i who viewed j}cᵢⱼuᵢ],
where ε represents a step size.

19. A method, comprising:
accessing a usage matrix M that stores first electronic data concerning a set of users and a set of items, where the first electronic data describes a latent space built on collaborative filtering based user to item interactions, where a user i is represented in M by a vector mᵢ, where an item j is represented in M by a vector mⱼ, and where user i is related to item j by a strength cᵢⱼ, i and j being integers;
producing, from M, second electronic data associated with a metric item space,
where the second electronic data is produced using a matrix factorization process on vectors associated with members of the set of users and on vectors associated with members of the set of items,
where the matrix factorization process does not perform negative sampling, and where the matrix factorization process considers the contributions of users to items, and
where the second electronic data includes a vector uᵢ that represents i and a vector vⱼ that represents j, where the elements of a vector measure the extent to which the entity associated with the vector possesses the factors associated with the dimensions in M; and
providing the second electronic data for use in making a recommendation of an item to acquire.

20. The method of claim 19,
where producing the second electronic data depends, at least in part, on at least fifty percent of the strengths cᵢⱼ in M,
where producing the second electronic data depends, at least in part, on the popularity of items represented in M, and
where producing the second electronic data depends, at least in part, on the popularity of users represented in M.

21. The method of claim 19, where producing the second electronic data depends, at least in part, on a total contribution factor U_{cache} for all items represented in M with respect to all users represented in M.

22. The method of claim 21, where U_{cache} is computed according to:
U_{cache}>=Σⱼ₌₁^{J}tⱼvⱼ,
where tⱼ represents a popularity of item j, where J represents the total number of items represented in M.

23. The method of claim 22, comprising:
creating a cache P_{cache} according to:
P_{cache}=Σⱼtⱼvⱼvⱼ^{T}.
creating a collection usercache, where usercache={U_{cache}, P_{cache}}, and
computing a Hessian matrix Pᵢ for user i according to:
Pᵢ=sᵢDP_{cache}+Σ_{j viewed by i}cᵢⱼvⱼvⱼ^{T}.

24. The method of claim 23, comprising computing, in parallel, a plurality of new user vectors associated with the metric space, where a new user vector uᵢ for a user i is computed according to:
uᵢ=−sᵢDU_{cache}+Σ_{j viewed by i}cᵢⱼvⱼ,
where D is a function of all values cᵢⱼ in M,
or according to:
uᵢ+Pᵢ⁻¹[−sᵢDU_{cache}+Σ_{j viewed by i}cᵢⱼvⱼ],
or according to:
uᵢ=(1−ε)uᵢ^{old}+ε[−sᵢDU_{cache}+Σ_{j viewed by i}cᵢⱼvⱼ],
where ε represents a step size.

25. The method of claim 24, where producing the second electronic data depends, at least in part, on a total contribution factor I_{cache} for all users represented in M with respect to all items represented in M, where I_{cache} is computed according to:
I_{cache}=Σᵢ₌₁^{I}sᵢuᵢ,
where sᵢ represents a popularity of user i, where I represents the total number of users represented in M.

26. The method of claim 25, comprising:
creating a cache Q_{cache} according to:
Q_{cache}=Σᵢsᵢuᵢuᵢ^{T},
creating a collection itemcache, where itemcache={I_{cache}, Q_{cache}}, and
computing a Hessian matrix Qⱼ for an item j according to:
Qⱼ=tⱼDQ_{cache}+Σ_{i who viewed j}cᵢⱼuᵢuᵢ^{T}.

27. The method of claim 26, comprising computing, in parallel, a plurality of new item vectors associated with the metric space, where a new item vector vⱼ for an item j is computed according to:
vⱼ=−tⱼDI_{cache}+Σ_{i who viewed j}cᵢⱼuᵢ,
or according to:
vⱼ=Qⱼ⁻¹[−tⱼDI_{cache}+Σ_{i who viewed j}cᵢⱼuᵢ],
or according to:
vⱼ=(1−ε)vⱼ^{old}+ε[−tⱼDI_{cache}+Σ_{i who viewed j}cᵢⱼuᵢ].

28. The method of claim 27, comprising producing the recommendation of the item to acquire, where the recommendation depends, at least in part, on the plurality of new item vectors and the plurality of new user vectors.

29. A computer-readable storage medium storing computer-executable instructions that when executed by a computer control the computer to perform a method, the method comprising:
accessing a usage matrix M that stores first electronic data concerning a set of users and a set of items, where the first electronic data describes a latent space built on collaborative filtering based user to item interactions, where a user i is represented in M by a vector mᵢ, where an item j is represented in M by a vector mⱼ, and where user i is related to item j by a strength cᵢⱼ, i and j being integers;
producing, from M, second electronic data associated with a metric item space, where the second electronic data is produced using a matrix factorization process on vectors associated with members of the set of users and on vectors associated with members of the set of items, where the matrix factorization process does not perform negative sampling, where the matrix factorization process considers the contributions of users to items, and where the second electronic data includes a vector uᵢ that represents user i and a vector vⱼ that represents item j, where the elements of a vector measure the extent to which the entity associated with the vector possesses the factors associated with the dimensions in M,
where producing the second electronic data depends, at least in part, on the strengths cᵢⱼ in M, on the popularity of items represented in M, and on the popularity of users represented in M,
where producing the second electronic data depends, at least in part, on a total contribution factor U_{cache} for all items represented in M with respect to all users represented in M;
where producing the second electronic data depends, at least in part, on a total contribution factor I_{cache} for all users represented in M with respect to all items represented in M;
computing, in parallel, a plurality of new user vectors associated with the metric space;
computing, in parallel, a plurality of new item vectors associated with the metric space, and
producing a recommendation of an item to acquire, where the recommendation depends, at least in part, on the plurality of new item vectors and the plurality of new user vectors.
